(19) United States
(12) Patent Application Publication
(10) Pub. No.: US 2019/0325769 A1
(43) Pub. Date: Oct. 24, 2019

(54) EDUCATIONAL TOOL FOR STANDALONE LESSONS

(71) Applicant: THE GLOBAL SCHOOLHOUSE INITIATIVE, Mississauga (CA)

(72) Inventors: Yasmeen SEHBAI, Blainville (CA); Omar NAJJAR, Blainville (CA)

(73) Assignee: THE GLOBAL SCHOOLHOUSE INITIATIVE, Mississauga (CA)

(21) Appl. No.: 16/387,276

(22) Filed: Apr. 17, 2019

Related U.S. Application Data
(60) Provisional application No. 62/658,947, filed on Apr. 17, 2018.

(51) Int. Cl. G09B 5/12; G06F 1/26; G06F 1/20

(52) U.S. Cl. CPC G09B 5/12; G06F 1/206; G06F 1/263

(57) ABSTRACT

The present invention is an educational tool comprising a server, a router and one or more computer devices. The server is operable to store data and transmit data to the computer device(s). The computer device(s) have computer software stored therein that is operable to function to provide educational materials to a user, and whereby an educator may prepare lessons and/or provide lessons to one or more students. The router is operable to function as a networking device, and the router forwards data between the server and one or more computer devices, as well as between an Internet connection and the server. The educator may utilize the one or more computer devices in order to prepare and provide lessons to the student(s). The server router and at least one computer device are stored in an educational tool housing that is impervious to environmental conditions. Each of the elements within the housing are removable from the housing.

This application claims the benefit of U.S. Provisional Patent Application Ser. No. 62/658,947 filed Apr. 17, 2019.

### FIELD OF INVENTION

This invention relates in general to the field of education tools and more particulary to education tools for remote locations, isolated students, or refugee camps.

### BACKGROUND OF THE INVENTION

In the past education tools have been developed to provide lessons to students and such prior art education tools generally require each student to have a computer device. The student utilizes the computer device to receive and view lessons and other educational materials. In such prior art educational tools, the student is further required to interact with the computer device in order to provide responses to the lessons and other education materials provided to the student. The interaction of the student with the computer device is generally tracked or monitored. The interaction is further evaluated, to determine whether the student has learned the information that was provided to the student through the education materials.

Such prior art education tools rely upon the computer device maintaining a regular Internet connection. Educational materials must be downloaded to the computer device via an Internet connection either during the use of the educational materials by the student, or otherwise on a regular or semi-regular basis, in order to keep the educational tool current. To initiate a download of educational materials, a request is generated through the student's use of the computer device or the use by another user of the computer device.

Prior art educational tools are further configured to offer progressive lessons. Such progressive lessons provide learning to students that is incrementally increased by each lesson. A student must follow through all of the lessons to achieve full learning in subject. Moreover, a student must have undertaken earlier lessons to be capable of understanding and learning later lessons.

Prior art education tools generally rely upon off-the-shelf computer devices that are susceptible to malfunction if used in a rough manner, or when exposed to harsh environmental conditions. For example, the function of off-the-shelf computer devices may be hampered or stopped due to environmental conditions such as extreme heat or cold, pervasive and significant quantities of sand or dust, persistent dampness, wet conditions, or other harsh environmental conditions. As the prior art educational tools require a functioning computer device, if the computer device stops working, or functions intermittently or very slowly, this can hamper a student's ability to learn from lessons and educational materials provided to the student through use of a prior art educational tool.

Prior art educational tools and systems can be ineffective in providing education to various populations of potential students around the globe. An example of such a population is potential students in refugee camps. The world is facing a global refugee crisis on nearly every continent, and prior art education tools and systems are not effective to teach students in the refugee population. According to the UNHCR, “An unprecedented 65.6 million people around the world have been forced from home. Among them are nearly 22.5 million refugees, over half of whom are under the age of 18” (http://www.unhcr.org/figures-at-a-glance.html). These children, adolescents or teenagers are being displaced from their homes every day due to war, food and water shortages, and economic instability. This means that approximately 11 million children, adolescents or teenagers around the world are in a situation where they do not have many of the basic necessities of life, let alone access to education.

What is needed is an educational tool that is self-sustaining that can be used by educators, who can include people without any formal teaching training, to provide stand-alone lessons to one or more students who are in remote areas, living in harsh conditions, choosing or requiring home schooling, or residing in refugee camps.

### SUMMARY OF THE INVENTION

In one aspect, the present disclosure relates to an educational tool, comprising: a router; a server having data relating to one or more lessons stored therein and being bilaterally connected to the router; and a computer device connected to the router, said computer device incorporating a software application operable to prepare the one or more lessons and a computer processor operable to receive the data from the server via the router and to provide such data to a user in accordance with commands of the software application.

In another aspect, the present disclosure relates to an educational tool further comprising the one or more lessons each being standalone lessons whereby the user can provided each of the one or more lessons to one or more students without said one or more students having attended any prerequisite lesson.

In another aspect, the present disclosure relates to an educational tool further comprising the computer device being connectable to the internet, and the server being operable to identify a URL transmitted to the service from the computer device browser and thereby operate a script to facilitate access to a central server and the receipt of updates from such central sever to the software application of the computer device.

In another aspect, the present disclosure relates to an educational tool further comprising the data including one or more of the following: applications to receive updates from the central server to the computer software; DNS server applications; DNS server configurations; lesson planning materials; and lesson content.

In another aspect, the present disclosure relates to an educational tool further comprising the one or more lessons incorporating content directed to content-based themes and social and emotional themes.

In another aspect, the present disclosure relates to an educational tool further comprising the one or more lessons incorporating content to facilitate assisting students with building and fostering self-efficiency skills and a perception of control.

In another aspect, the present disclosure relates to an educational tool further comprising each of the one or more lessons incorporating content directed to two or more levels of learning.

In another aspect, the present disclosure relates to an educational tool further comprising the one or more lessons being preparable and teachable to one or more students by a person devoid of instructor training.

In another aspect, the present disclosure relates to an educational tool further comprising a rechargeable battery operable to provide power to one or more of the following: the router, the server, the computer device, and one or more external elements, wherein said rechargeable battery is attached to a power source that is one or more solar panels, and the one or more external elements include one or more of the following: one or more projectors; one or more speakers, one or more microphones, one or more screens, one or more televisions, one or more gaming and entertainment consoles, and one or more smart home consoles.

In another aspect, the present disclosure relates to an educational tool further comprising a housing being configured to contain one or more of the following: the router; the server; the computer device; a rechargeable battery; a battery charger; and a power inverter.

In another aspect, the present disclosure relates to an educational tool further comprising the housing being configured to withstand environmental conditions, including being configured in the manner of one or more of the following: to resist or otherwise expel sand and dust from entering the housing, thereby protecting the contents of the housing from clogging due to sand or dust; to be insulated against cold and heat; to have low functions of conducting of heat and cold; to withstand exposure to environmental elements; to withstand wear and tear, including one or more of the following: bumping, being dropped, and being under weight or other pressure.

In yet another aspect the present disclosure relates to an educational tool, comprising: a housing containing: a router; and a server having data relating to one or more lessons stored therein and being bilaterally connected to the router; and a computer device connected to the router, said computer device incorporating a software application operable to prepare the one or more lessons and a computer processor operable to receive the data from the server via the router and to provide such data to a user in accordance with commands of the software application.

In another aspect, the present disclosure relates to an educational tool further comprising the housing being configured to withstand environmental conditions, including being configured in the manner of one or more of the following: to resist or otherwise expel sand and dust from entering the housing, thereby protecting the contents of the housing from clogging due to sand or dust; to be insulated against cold and heat; to have low functions of conducting of heat and cold; to withstand exposure to environmental elements; to withstand wear and tear, including one or more of the following: bumping, being dropped, and being under weight or other pressure.

In another aspect, the present disclosure relates to an educational tool further comprising the server incorporating one or more of the following: a LAMP server, a DNS server and a update daemon.

In another aspect, the present disclosure relates to an educational tool further comprising the server being connectable to the internet, and via such internet connection being connectable to a central server.

In another aspect, the present disclosure relates to an educational tool further comprising the computer device having a browser function incorporated therein.

In another aspect, the present disclosure relates to an educational tool further comprising the housing being configured to further contain one or more of the following: the computer device; a rechargeable battery; a battery charger; and a power inverter.

In another aspect, the present disclosure relates to an educational tool further comprising a computer device housing being configured contain the computer device and to withstand environmental conditions, including being configured in the manner of one or more of the following: to resist or otherwise expel sand and dust from entering the housing, thereby protecting the contents of the housing from clogging due to sand or dust; to be insulated against cold and heat; to have low functions of conducting of heat and cold; to withstand exposure to environmental elements; to withstand wear and tear, including one or more of the following: bumping, being dropped, and being under weight or other pressure.

In another aspect, the present disclosure relates to an educational tool further comprising one or more additional computer devices being connected to the router.

In another aspect, the present disclosure relates to an educational tool further comprising a rechargeable battery operable to provide power to one or more of the following: the router, the server, the computer device, and one or more external elements.

In another aspect, the present disclosure relates to an educational tool further comprising one or more of the following: the rechargeable battery being attached to a power source that is one or more solar panels; and the one or more external elements including one or more of the following: one or more projectors; one or more speakers, one or more microphones, one or more screens, one or more televisions, one or more gaming and entertainment consoles, and one or more smart home consoles.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to he understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a systems drawings of an embodiment of the present invention operable when the server is connected to the computing device and the server is connected to the Internet.

FIG. 2 is a systems drawing of a transfer of information between elements of the present invention.

FIG. 3 is a representative drawing of elements of an embodiment of the present invention inside a housing.

FIG. 4 is a representative drawing of elements of an embodiment of the present invention inside multiple housings.

FIG. 5 is a representative drawing of elements of an embodiment of the present invention inside a housing.

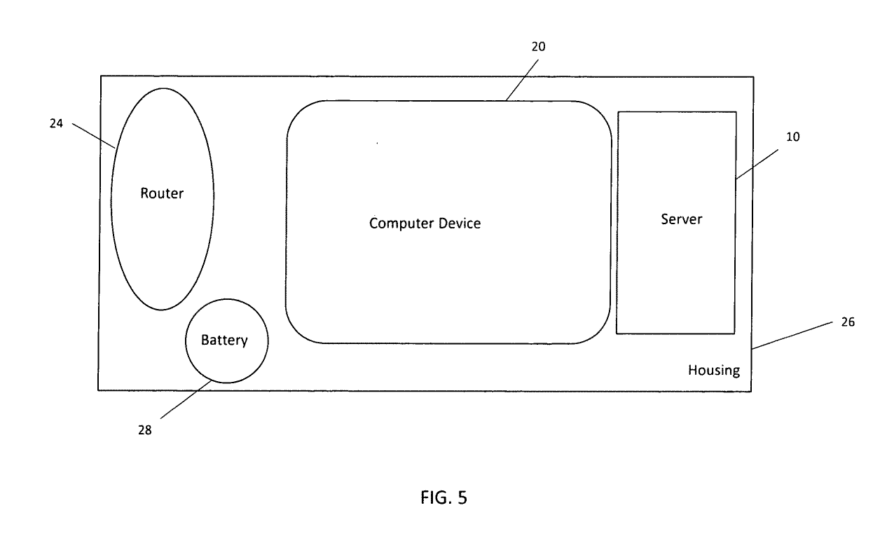

FIG. 6 is a systems drawing of elements of an embodiment of the present invention internal and external to a housing.

FIG. 7 is a systems drawing of an embodiment of the present invention operable when the system is not connected to the Internet.

FIG. 8 is a systems drawing of an embodiment of the present invention operable when the system is connected to the Internet and the computing device is removed from the housing.

FIG. 9 is a systems drawing of an embodiment of the present invention incorporating multiple computing devices.

FIG. 10 is a systems drawing of a possible configuration of an embodiment of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is an educational tool comprising a server, a router and one or more computer devices. The server is operable to store data and transmit data to the computer device(s). The computer device(s) have computer software stored therein that is operable to function to provide educational materials to a user, and whereby an educator may prepare lessons and/or provide lessons to one or more students. The router is operable to function as a networking device, and the router forwards data between the server and one or more computer devices, as well as between an Internet connection and the server. The educator may utilize the one or more computer devices in order to prepare and provide lessons to the student(s). The server router and at least one computer device are stored in an educational tool housing that is impervious to environmental conditions. Each of the elements within the housing are removable from the housing.

Embodiments of the present invention may incorporate a projector. In some embodiments of the present invention the projector may be utilized in providing information to the educator. In other embodiments of the present invention the projector may also be utilized by the educator to provide information relating to a lesson to the student(s).

The term “computer device” or “computing device” as used herein will mean any laptop computer, smart phone, tablet or other computer enabled device.

The term “educator” as used herein will mean any person who utilizes the present invention to provide one or more lessons to one or more students. The education may be a person with teaching training, such as a trained instructor or teacher, or any other person who has at least basic reading skills.

The term “lesson” as used herein will mean collectively any lesson planning materials and lesson content, or other information, relating to a lesson of an educational program, that is to be provided by an educator to one or more students through use of the educational tool of the present invention. The educational tool is developed to incorporate an educational program that may include a curriculum, or curricula, for students of one or more education levels. Each curriculum will incorporate one or more lessons.

The term “data” as used herein will mean any information, or collection of information, whether in a raw or processed form, that is either generated by the present invention, or that is downloaded to the server of the present invention.

The terms “computer software” and “software” as used herein will mean any software code whereby the computer processor of a computer device is operated to function in accordance with commands embedded in the software code.

The term “central server” as used herein will mean one or more servers accessible and operable by a systems operator. The systems operator may develop and maintain embodiments of the present invention. Updates to the computer software stored and operated by the computing device of the present invention, and other data for embodiments of the present invention, are stored in the central server. The central server may further receive and store data and other information transferred from the server of an embodiment of the present invention, and such transferred data and other information may be processed by computer software code operable by the systems operator. Such computer software code may be operable by the systems operator through use of the server and/or a computing device. The central sever may be located remotely from the server of any embodiment of the present invention.

The present invention is a “plug 'n play” approach to education. Embodiments of the present invention may eliminate the need for licensed teachers, standardized education, and government funding to provide education to a student population. Embodiments of the present invention require minimal equipment, resources and funding to implement and maintain. A community equipped with an embodiment of the present invention can run a fully functional and self-sustaining educational program. The educational program of the educational tool of embodiments of the present invention can be tailored to a specific student population, such as a refugee student population, or any other student population. The educational program may be utilized to provide emergency education to a student population, whereby a student population that would not otherwise receive any education will receive one or more lessons. When utilized to provide emergency education, and in other circumstances of use, the present invention may not require any standardized lessons be provided or any specific school-board approved education program or curriculum be followed in providing lessons. Students may participate in one or more lessons of the present invention without being evaluated, or being assessed. For example, students will not be evaluated or assessed to determine if they have achieved any milestones required prior to any diploma or certification being granted. The lessons of the present invention may incorporate both traditional scholastic subject matter (e.g., science, language, literature, history, geography, mathematics) or any other subject matter. The lessons of the present invention may further incorporate content that focuses on resilience, positive psychology, and global knowledge.

In embodiments of the present invention, the educational tool, including lessons and other content, may be translated into the native language of the student population, or the language of the population of any community or region, where the educational tool is utilized. In some embodiments of the present invention the lessons and other content of the educational tool may be translated into multiple languages if the student population comprises students who speak multiple languages.

The content, data and computer software of the present invention can be directed to a specific demographic and may aim to help students build skills they need to develop and thrive within their demographic. For example, in an embodiment of the present invention incorporating lessons developed for a refugee population, the lessons may help students build resilience skills. It is also possible for the educational program content, data and computer software of the present invention to be developed to be general, and not directed to any specific student population. Such an embodiment of the present invention may be utilized by a variety of student populations.

The curriculum of some embodiments of the present invention may incorporate theme based lessons. Theme based lessons differ from progressive learning of subjects over a succession of related lessons. Each theme based lesson is an individual lesson incorporating one or more themes. The themes may be: content-based (e.g., subject matter such as history, science, literature, physical education, geography, mathematics, or other subject matter); and emotional and/or social based. The content-based themes of lessons generally provided to be basic, global, and culturally sensitive. The content-based theme incorporated in a lesson provides students with general knowledge they can use in any area of the world. The content-based theme component of a lesson will further provide students with knowledge that they will carry with them through their lives. Social and/or emotional themes of lessons may be directed to developing and fostering attributes in students that help the students thrive in their communities.

In such an embodiment of the present invention that incorporates theme-based lessons, it is possible that overarching themes may be incorporated in multiple lessons. Such overarching themes may assist students with developing skills, such as aiming to encourage and foster global peace, and/or other global goals, for example, such as educating the most under privileged citizens of the world, or other goals. These types of overarching themes may be social and/or emotional themes. As an example, the content-based themes of individual lessons may be high interest topics within a subject area, and overarching themes of those same lessons may be social/emotional themes that can help shape students into well-rounded adults.

In some embodiments of the present invention, the curriculum of an educational program may be organized in a manner that is not theme based.

Lesson planning materials and/or lesson content are provided to an educator through the educator's use of a computing device. The computing device has computer software stored therein operable to provide the lesson planning materials and/or lesson content to the educator. In some embodiments of the present invention, the computer software may incorporate one or more modules. For example, the modules may include modules focused upon particular subject matter (i.e., history, science, literature, physical education, geography, mathematics, or other subject matter), or at specific educational levels (i.e., grade levels or other education levels). Lessons may be integrated into modules in some embodiments of the present invention.

The computer software will be operable to provide to the educator lesson planning materials and/or lesson content for multiple lessons. In some embodiments of the present invention, the computer software may also be operable to provide lesson content for multiple lessons directly to one or more students. In this manner lesson content may be provided to said students individually. In some embodiments of the present invention, the software may be operable to provide lesson planning materials and/or lesson content in a particular sequential order. In other embodiments of the present invention the software may be operable to provide lesson planning materials and/or lesson content in an order selected by an educator, or in a random order.

The lessons of an educational program and/or a curriculum collectively provide teaching to the student(s) on a variety of topics and subjects. Individual lessons and/or lessons collectively may provide teaching to the student(s) at one or more grade levels.

In some embodiments of the present invention, the themes or other content incorporated in the lessons may have been developed such that the student(s) at different educational levels (i.e., different grade levels, or other educational levels), can learn simultaneously from a lesson being provided to such student(s). As an example, students at the grade levels of kindergarten to grade 2 may be grouped together. Each lesson may incorporate lesson content identified as “Support”, “Grade level” and “Stretch” sections. The incorporation of such sections within a lesson may allow students with different needs and abilities to participate in the same lesson. For example, students at a higher educational level may need an educational challenge, and such students can complete the “Stretch” section which will provide lesson content at a higher educational level than the general lesson content and the other sections available in the lesson. As another example, students who are at a specific educational level may access lesson content specific to an educational level by accessing the “Grade level” section of the lesson content. For example, a lesson created for students at the grade levels of kindergarten to grade 2 may include Grade level sections for kindergarten, for Grade 1 and for Grade 2. As yet another example, students who are below the lowest educational level that the lesson is to be provided to, may need the lesson simplified. Such students can access the “Support” section of the lesson, and thereby receive lesson content that is at a lower educational level than the lowest educational level to which the lesson is to be provided.

The inclusion of sections in the lesson content allows for the teaching of the lesson to be applicable to each of the one or more students attending a lesson each time the lesson is taught. Lessons can thereby be applicable to multiple students attending a single lesson, despite the variety of circumstances affecting such students. The lessons can further be easily taught to a student population that is unpredictable, and that may include different students of variant educational levels from day-to-day and from lesson-to-lesson.

Social and/or emotional themes can be incorporated in lessons. Such social and/or emotional themes of the lessons may take the student's hardships and circumstances into consideration. Social and/or emotional themes may further be developed to help students build and foster coping skills for such hardships and circumstances. The social and/or emotional themes may empower the students with tools to develop and foster resilience in relation to such hardships and circumstances.

The lessons may integrate elements of key factors identified in promoting the development and fostering of resilience, including: (1) facilitating supportive adult-child relationships; (2) building a sense of self-efficacy and perceived control; (3) providing opportunities to strengthen self-regulatory capacities; and (4) mobilizing sources of faith (e.g., non-religious faith, or non-denominational religious faith), hope, and cultural tradition. The lessons may also be developed to facilitate supportive adult-child relationships by encouraging an adult (the educator) to educate the students at a time when said students feel despondent, such as may be experienced by a student at a refugee camp. The lessons may assist students with building and fostering self-efficacy skills and a perception of control. The lessons may cover subject areas that allow the students to learn how to be contributing global citizens, develop an understanding, or a deeper or clearer understanding, of how the world works, and the individual role they play in this world.

The lessons of the present invention may be incorporated in a curriculum. A curriculum may incorporate any number of educational levels, subjects and lessons. As an example of a curriculum of an embodiment of the present invention, it may include an educational level that incorporates seven subject areas and four lessons. Each lesson may focus on one or more of the seven subject areas. The lesson content of each lesson may be distributed between content-based themes (e.g., history, science, literature, physical education, geography, mathematics, or other subject matter) and social and/or emotional themes. The balance of such themes in each lesson may vary. For example, of the four lessons, two lessons may be developed to be predominantly directed to one or more content-based themes, and two lessons may be developed to be predominantly directed to one or more social and/or emotional themes.

A lesson that is predominantly focused on content-based themes may incorporate a significant amount of information relating to subjects such as math and science. Another lesson may incorporate more information relating to social and/or emotional themes, such as peace education or art, and therefore be predominantly a social and/or emotional theme focused lesson.

Students are not required, and do not need, to participate in, or otherwise receive, the lessons in any type of sequence. Students can freely between lessons and participate in, or otherwise receive, the lessons in any order. The fluid methodology of the lessons allows for a changing classroom from day to day, so that the students are never left learning the same thing over and over again if new students attend or if a new educator is providing a lesson. A date stamp and/or time stamp (whether physical or digital) will be placed after the completion of every lesson, so that the next educator to take over and provide a lesson can be aware of the lessons that have been provided by the prior educator(s).

In some embodiments of the present invention, a survey or questionnaire may be provided to the educator through operation of the computer software on the computer device utilized by the educator. The computer software may operate to request, or require, the educator to complete the survey or questionnaire. The results of the surveys or questionnaires may be transferred from the computing device utilized by the educator via the router to the server. The results may then be uploaded to the central server via the Internet the next time that the server is connected to the Internet. Such surveys or questionnaires may be developed to collect various types of data, for example, such as data relating to the number of students attending lessons, the educator's experience of using the lesson plans to provide lessons to the students, the lesson content used to provide the lessons to the students, or other information relating to the students attending the lessons, the educator's experience with utilizing the computer device and lesson plans, or with the educator's experience providing the lessons to the students.

Data may be generated by the one or more computer devices through use of such computer device(s) by an educator and/or students. Such data may include information relating to the use of the lesson planning materials and/or lesson content, information relating to the educator and/or the students, or information incorporated in the lesson planning materials and/or lesson content. The data may further incorporate the results of surveys and/or questionnaires completed by an educator. The computer software may be operable to process data and/or generate new data based upon the processing of data. Data may be stored in the hard drive of the computing device and/or in the server. Data may incorporate information or other content that can be viewed, read or heard, or any combination of the foregoing. Data may also be transferred from the central server via the Internet to the server, and thereby provided to an educator and/or one or more students when such data is transferred to a computing device via the router. Data may be utilized by the educator through operation of the computer device, to prepare and/or provide one or more lessons to the student(s).

In embodiments of the present invention, data may further include customer applications or scripts to be operated by the server including: applications to receive updates from the central server to the computer software or any scripts or software code stored in the server; LAMP server applications and/or configurations; DNS server applications and/or configurations; and/or lesson planning materials and lesson content. The data may further include any of the following stored on the one or more computer devices: presentation software; and/or presentation materials that may include digital materials as well as materials to be printed or otherwise provided in a hard copy format.

The server runs a custom DNS server operable to identify a URL from the computer device browser and thereby access the lessons. The custom DNS is operable to allow clients to log into an application via the identified URL address. No other configuration is necessary.

The server and the router are plug'n play or turn-key, and ready for immediate use. The data and content delivery is made possible by the use of a LAMP server application that runs on the server. The LAMP server in some embodiments of the present invention may be a Linux based webserver. Additionally, an update daemon will monitor for the opening and closing of the connection to the Internet. The update daemon is operable as a background process or application. Once a connection is made, the server will automatically connect to a backend control plane and allow for updates. In some embodiments of the present invention, the connection will be a secure connection. The backend control plane will be a content server that is integrated with, or linked to, the central server. For example, if the educational tool is used to deliver lessons to students in an area where no Internet is locally available, if a person were to take the server to an area where Internet services are available, such as a town, as soon as such person plugs in a network cable an update will be performed automatically. The update will occur in a timely manner. The person's input will not be needed to either initiate, end or assist in any manner with the update.

Embodiments of the present invention may incorporate particular security protocols. For example, embodiments of the present invention may have several security mechanisms built into the present invention and its use. The computer device(s) will automatically update software and firmware versions to minimize security gaps and vulnerabilities. The computer device(s) in some embodiments of the present invention will have customized operating systems that include airtight or virtually airtight security policies. As data is stored in the server, embodiments of the present invention can be configured such that the computer device(s) will not host any sensitive data, and will run in a closed-loop setup. Servers will not have any peripheral accessories (e.g., monitor, keyboard, mouse, etc.). When the server is connected to the Internet the server's real-time location may be tracked using the Internet protocol address.

When the server is located in the vicinity of an Internet connection that the server can access and utilize, the server will automatically download any updates to the initial data. Such downloads will occur through operation of the update daemon. The educator, or any other user, is not required to take any action to initiate such download. The updates will be directed from the central server via the Internet to the server, in accordance with programmed computer instructions of the update daemon that exists in the server. The downloaded updates will be stored in the server. When the educator next utilizes the computer device, the updates will be accessible from the server by the computer device via the router. In this manner, the educator will receive updated information to prepare and/or provide lessons to one or more students. The computer device utilized by the educator does not need to be connected to the Internet during the lesson, nor is the computer device required to be connected to the Internet on a regular basis.

The educational tool may incorporate one or more lessons. The lessons may be configured to be taught, directed or otherwise provided to one or more students who live in remote areas of the world, who do not attend the lessons regularly, and who have particular environmental or cultural experiences. For example, the educational tool lessons may be configured to be delivered, or otherwise provided, to one or more students living in refugee camps, remote villages, or other areas in the world, or in environments, that cause regular attendance at school to be difficult for a student. The educational tool of embodiments of the present invention may further be utilized for homeschooling. Versions of the lessons in some embodiments of the present invention may be configured to comply with governmental educational requirements, and such versions may be utilized in countries where governmental educational requirements are imposed.

The educator does not require any formal training as a teacher. The educator will solely be required to have reading skills in order to understand the lesson information and to prepare and/or provide the lesson to one or more students. All of the information that the educator will require to prepare and/or provide a lesson to the student(s) is provided in the lesson planning materials, lesson content and/or other data stored in the server. Such lesson planning materials, lesson content and/or other data is delivered to the educator through the computer device. ‘The lesson planning materials for each lesson incorporate a script for the lesson. The script assists an educator in providing a lesson to the student(s). An educator can provide the scripted lesson content to the student(s). The script also ensures that the learning experience of the student(s) will not be adversely affected if different educators provide lessons of the educational tool to the student(s). The scripts will allow an educator to provide specific information and lesson content to the student(s) and can create continuity amongst lessons, even if the lessons are provided to the student(s) by different educators.

The educator may need the computer device to be functioning while the educator is delivering the lesson to the students. In some embodiments of the present invention, an educator may produce hard copies of the lesson content and lesson script, and be able to provide the lesson to the student(s) without the computer device functioning during all, or a portion, of the time when the educator is providing the lesson to the student(s). In such an embodiment of the present invention, the educator can continue to provide a lesson to the student(s) even if the computing device ceases to function, such as can occur due to a power outage, or if the battery of the computing device, or any other battery incorporated in the present invention, is drained of power.

The computer device may function as a teaching aid for an educator, either to assist the educator with lesson planning and lesson preparation, and/or to assist the educator with providing a lesson and lesson content to the student(s). Utilizing the computer device to provide a lesson to the student(s) may be optional. If the computer device is used to provide a lesson to the student(s), as well as providing a script to the educator, the computing device may be used to display material to the student(s) on the screen of the computer device, or to provide audio content to the student(s), or to otherwise provide lesson content to the student(s). In some embodiments of the present invention, the educator will not need to display or otherwise provide lesson content or other information directly from the computer device to the student(s) to effectively provide a lesson to the student(s).

Embodiments of the present invention may incorporate a power source, such as a rechargeable battery. The battery may be recharged by intermittent connection to a power source. The present invention may further incorporate one or more solar panels that may be utilized to generate power that is stored in the battery and utilized to power the present invention.

Each lesson is designed to provide standalone information to a student. The student does not require any prior knowledge, or any collection of information, in order to understand and learn from the lesson. For example, the lessons are not configured into units, whereby each unit incorporates multiple lessons, and a student is required to have received earlier lessons in the unit (pre-requisite lessons) in order to understand a subsequent lesson in the unit. The present invention is developed such that a student can understand and learn from each lesson individually. A student can receive effective education no matter when a student engages in a lesson. For example, if a first student undertakes lessons that are taught by the same educator (or by different educators) on a regular basis over a series of weeks, and a second student undertakes a single lesson, each of the first and second students can learn the same information from the lesson that both students undertake. No prior knowledge, or undertaking of any prior lessons, are required for a student to learn from a lesson.

Although the educator requires a computer device to prepare and/or provide a lesson to one or more students, none of the students require a computer device to receive and/or learn one or more lessons. Moreover, none of the students require any interaction with a computer device to receive and/or learn any lesson. One or more students may own or otherwise have access to a computer device during the lessons. Such computer devices may be utilized by said one or more students to view visual content and/or hear audio content provided by an educator to the student(s) during a lesson. The present invention does not require that any student data is uploaded from the computer device or server.

It is possible that in some embodiments of the present invention some student data may be uploaded to the central server in an anonymized and/or aggregated form. Such data may be anonymized and/or aggregated by operation of the computer software of the computer device, or may be collected in a manner whereby the data is anonymous.

Data pertaining to the educator's use of, or other interaction with, the computing device may also be uploaded from the computing device. In such embodiments of the present invention, student and/or educator data may be uploaded from the computer device to the server via the router. The data can then be uploaded from the server via the Internet when the server is connected to the Internet. The information uploaded via the Internet can be directed to the central server or another a data collection source relating to the educational tool. Such uploaded data may be processed and analyzed by the central server or the data collection source, or by any computerized device connected thereto (whether by wired connection, wireless connection, or by a network or Internet connection), the foregoing collectively constitute the central server system. All transfers of information from the server to the central server system, or to any other remote server, may be through a secure connection.

One or more reports may be generated by operation of the central server system that convey the results of such processing and analysis. Such reports may be of any type and in any format, and may be utilized to: develop, modify and improve the educational tool; and/or to create updates to the educational tool and new versions of the lessons.

The computer device may be stored in a housing with the router and server. Each of the computer device, router and server may be removed from the housing when the housing is opened. For example, the computer device may be removed from the housing when the computer device is utilized by an educator. Other elements of embodiments of the present invention may also be stored within a housing, including a battery, a projector, or multiple computing devices.

The housing is configured to protect its contents from the conditions that surround the housing, for example, such as environmental conditions (e.g., extreme heat or cold, pervasive and significant quantities of sand or dust, persistent dampness, wet conditions, or other harsh environmental conditions), or conditions that induce wear and tear. For example, the housing may be configured to be formed of materials that do not conduct heat and/or cold well, and may further be insulated against heat and/or cold. The housing may also be formed of materials that are resistant to wet conditions, so that the contents of the housing will remain dry. The materials that the housing is formed of may additionally be resistant to extreme dry conditions, such that the materials will not crack or otherwise become compromised by dry conditions. The housing may also be configured to resist or otherwise expel sand and/or dust from entering the housing, thereby protecting the contents of the housing from clogging due to sand and/or dust. The housing may be configured to maintain its integrity under wear and tear, including bumping, being dropped, being under weight or other pressure, or any other type of wear and tear. The server and computer device(s) may be fan-less and diskless and thereby be durable in harsh environments,

In embodiments of the present invention, the configuration of the elements of the present invention may be in accordance with achieving a low maintenance solution educational tool.

In embodiments of the present invention, the housing may be securable against theft, for example, such as by a locking mechanism, whereby the housing is locked or otherwise secured to an immoveable structural element, such as a post within a building, an immoveable desk, or some other secure element.

The present invention offers several benefits over prior art educational tools. The elements of the present invention are limited in number, and may be collectively and individually portable. Prior art educational tools often require sophisticated equipment with numerous elements, and are therefore difficult to transport and not portable by a single person. The present invention may be easily transported into remote locations, due to its limited number of elements and inherent portability.

Another benefit that the present invention offers over the prior art is that the present invention does not require every student to have a computer device in order to receive lessons and teaching. The prior art educational tools generally require each student to have a computer device in order for such student to be able to engage in and learn from lessons. The present invention is more effective in providing education to students in remote and economically challenged areas due to the fact that the educator is the only person required to have a computer device. The students are not required to each have a computer device. This provides further benefits over the prior art including that, in order for each student to receive an education from use of the present invention, there is no need: to transport multiple computer devices; to have sufficient power to power multiple computer devices; or to protect multiple computer devices from environmental conditions and wear and tear.

Another benefit of the present invention over the prior art is that the housing protects the elements of the present invention from harsh environmental and use conditions. Prior art educational tools that incorporate sophisticated equipment often require careful treatment to avoid damage that leads to system failures. The elements of prior art educational tools are also susceptible to damage due to exposure to harsh environments, such as extreme heat, extreme cold, dust, sand and other environmental conditions. The housing of the present invention protects the elements of the present invention and permits use of the present invention in remote areas, under wear and tear and extreme environmental conditions.

Another benefit of the present invention over the prior art is that the present invention does not require either a reliable consistent power source, or a reliable consistent Internet connection. Power sources and Internet connections can be intermittent or non-existent in many areas of the world, including refugee camps and remote villages. Prior art systems that require power sources to provide lessons, and Internet connections to prepare and/or provide the lessons, can lead to disruption in a student's learning if power and Internet connections are not available. The present invention does not require either power or the Internet on a regular basis, or at all during the time when an educator teaches the student(s). Therefore, the present invention can be used in regions of the world where prior art educational tools cannot be utilized. When using the educational tool of the present invention, a student's learning during a lesson will not be disrupted by any interruption or unavailability of power or the Internet. Some embodiments of the present invention may be power-autonomous and operable to generate power, for example, such as by having a power source and battery incorporated therein. In an embodiment of the present invention, the power source may be a solar panel that is connected to a battery.

Another benefit of the present invention over the prior art is that the present invention incorporates standalone lessons. Prior art educational tools are configured to provide progressive learning, whereby information is provided to a student over a series of inter-related lessons that build upon each other, such that prior lessons in the series of lessons are prerequisites for a student to understand later lessons. The lessons of the present invention are standalone, such that a student can learn from a lesson without needing to have received any prerequisite lesson content. This has the benefit that students who cannot attend lessons regularly, such as students in a refugee camp or other transient environments, can learn from a lesson without having received any prior information during any prerequisite lesson.

Another benefit of the present invention over the prior art is that the user is not required to take any steps to cause updates to be downloaded from the Internet. Prior art educational tools require a user to take steps to cause any updates to be downloaded from the Internet. The present invention only requires that the server be connected to the Internet from time to time, which will occur when the server is carried into the vicinity of an Internet connection. Once an Internet connection is established the download of updates to the educational tool from the central server to the server via the Internet will occur. Some embodiments of the present invention may also cause uploads from the server to the central server via the Internet to occur. The user is not required to take any steps other than carrying the server into the vicinity of an Internet connection.

Another benefit of the present invention over the prior art is that the educator is not required to be a trained teacher. Prior art educational tools are developed to be taught by a trained teacher. The present invention allows for any person who has reading skills to be able to provide one or more lessons to one or more students. This allows for the present invention to be used to provide education to one or more students in areas devoid of trained teachers.

The present invention may have several embodiments, including those shown in the drawings. A skilled reader will recognize that the embodiments of the present invention shown in the drawings are provided as examples of some embodiments of the present invention.

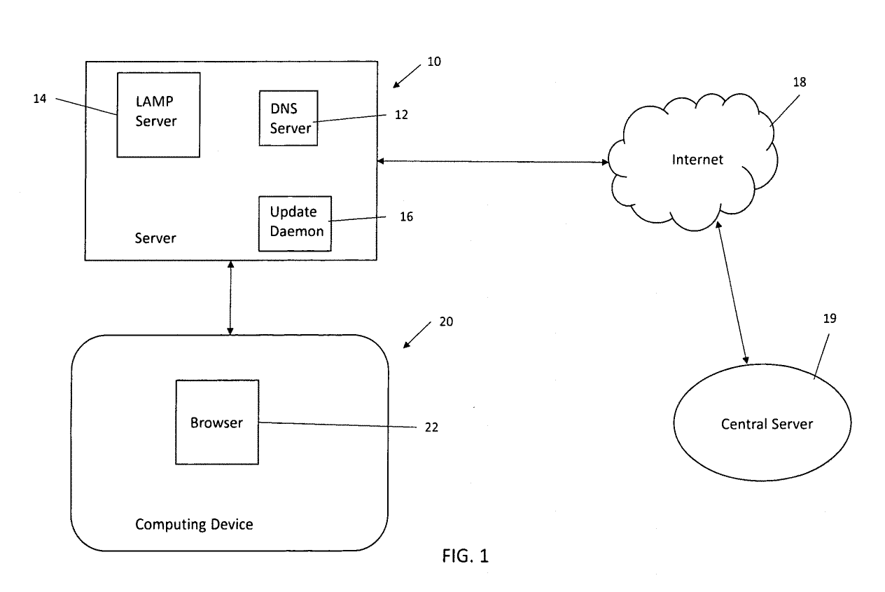

Embodiments of the present invention constitute an educational tool. As shown in FIG. 1 the present invention may incorporate a server 10 and a computer device 20. The computer device is pre-installed with computer software and other data. The computer device is operable to provide information relating to an educational program, including lesson planning materials and lesson content, whereby an educator can prepare one or more lessons to be delivered to one or more students. In some embodiments of the present invention the computer software may also be operable to provide lesson content or other information to one or more students during a lesson.

The server 10 may be connected to the Internet 18, and via the Internet be connected to a central server 19. Data may be transferred bilaterally (bi-directionally) between the central server and the server. Data transferred to the sever may further be transferred to the computing device. The computing device may incorporate a browser 22 that is operable to search for and connect to particular websites available via the Internet. Data may be transferred from the computer device to the server, and then be transferred from the server to the central server, via the Internet. In some embodiments of the present invention, data may be transferred (uni-directionally or bi-directionally) between the server and a remote server that is either identified in the educational tool or selected by an educator via the Internet. Alternatively, some data may be transferred from the computer device to be stored on the server, and such data is not transferred to the central server, or any other remote server, via the Internet.

Through the Internet connection the server can receive updates to data that is stored in the server. Such updates are integrated into the data that is accessible to the educator through use of the computing device. Through the Internet connection the server can further receive updates to the computer software stored in the computing device. Such computer software updates can be downloaded from the server to the computing device. All computer software updates are integrated into the computer software that is operable by the educator through use of the computing device. The updates to data and computer software are transparent to the educator. In this manner the lessons prepared for, and delivered to, the student(s) can be updated with new or additional data and/or operability.

The server 10 may incorporate a LAMP server 14 operable to serve the webpages that the present invention utilizes. The LAMP server is operable to serve computing devices and other client devices on the same network as the router. The LAMP server may be utilized to process data it receives from the computing device and/or that it receives via the router from the computing device(s) and other client devices connected to the router. The LAMP server may further be utilized to transfer such processed data bilaterally (bi-directionally) via the Internet. As an example, such data may incorporate statistics relating the use of the present invention by educators and/or students, and may indicate the percentage of students who undertake lessons via the educational tool of the present invention and completes all of the lessons in a curriculum at a specific educational level.

The server 10 may further incorporate a DNS server 12 operable to provide access to a website that is identified to the DNS server as a “home” website. The home website may access data and other information stored on the central server or some other remote server. The home website may provide access to specific educator information, or other data. The data and other information accessible via the home website may be transferred via the Internet to the server, whereby such data and other information is accessible by the educator through use of the computer device. Otherwise the educator may access such information when the educator is utilizing a computing device directly connected to the home website via the Internet. Such data and other information, including educator information, may be password protected, or otherwise only accessible by one or more educators.

The server 10 may also incorporate an update daemon 16 that is stored upon the server. The update daemon is operable to facilitate the automatic connection between the server and the central server via an Internet connection. The update daemon may further initiate any downloads or uploads of data between the server and the home website, or any other website, via the Internet. For example, the update daemon will initiate downloading updates to the data or computer software of the present invention.

As an example, the update daemon may be operable to download updates that include new lesson content from the central server to the server. The update daemon may further be operable to upload statistics data from the server to the central server. The computer device(s) may request website data for display on the browser. The website data presented will be served by the LAMP server. The activity of the server in uploading and downloading data to and from the central server is not affected by the number of computer devices connected to the server via the router.

In some embodiments of the present invention, the Internet connection may be an Ethernet connection, whereas in other embodiments of the present invention the Internet connection may be a Wi-Fi connection. The present invention may be configured to facilitate either an Ethernet or a Wi-Fi connection, such that the server may be operable with either type of connection. The server 10 may be equipped with a WiFi router access point.

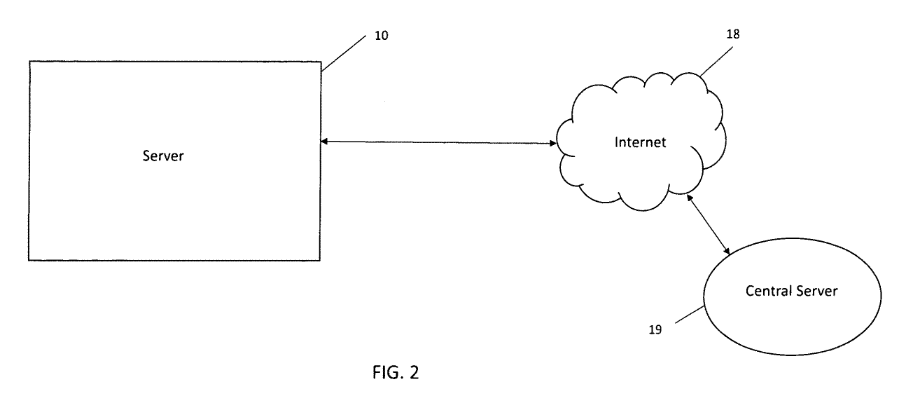

As shown in FIG. 2, if the server 10 is in the vicinity of an Internet connection 18, the server may establish an Internet connection and upload and/or download data or other information bilaterally (bi-directionally) between the server and the central server 19 (or some other remote server), via the Internet. The server may be unconnected to any computer device both when such connection to the Internet is established, and when the uploads and/or downloads to and from the server occur.

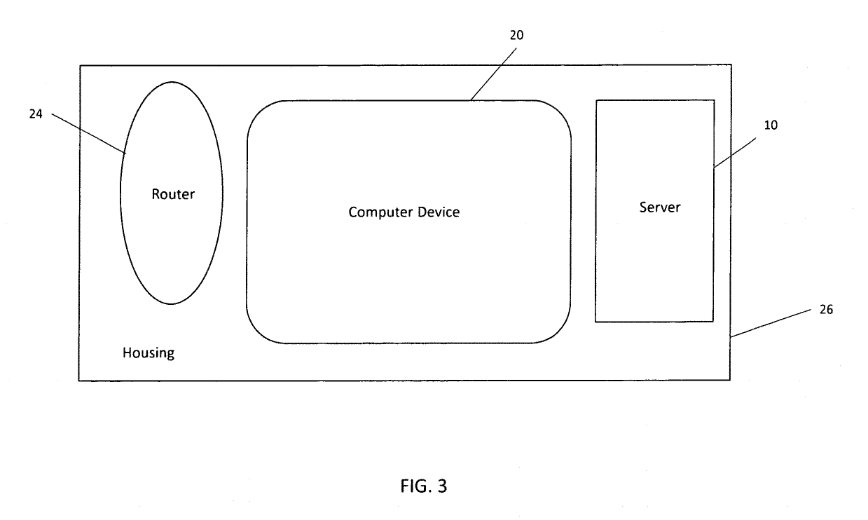

In embodiments of the present invention, at least one element of the present invention may be stored or otherwise incorporated in a housing. For example, as shown in FIG. 3, a router 24, computer device 20 and server 10 may be stored in a housing.

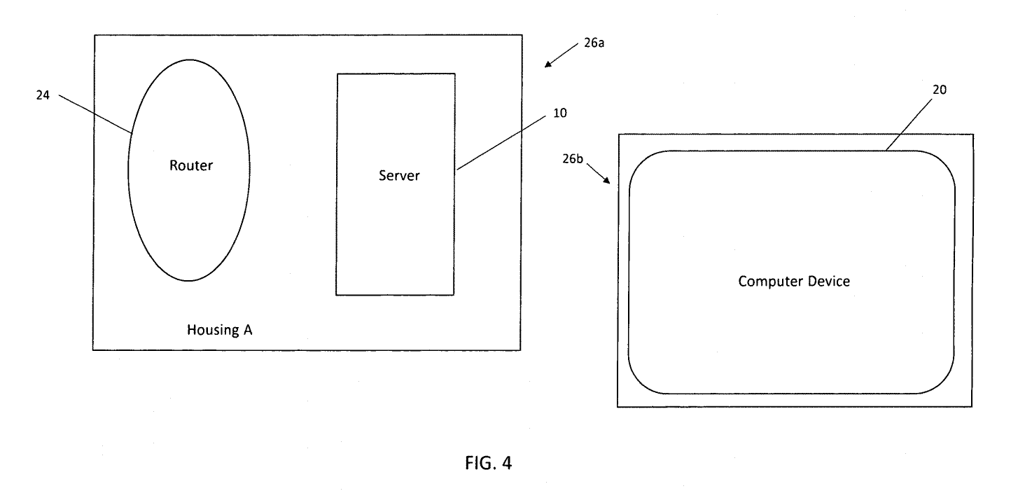

Some embodiments of the present invention may incorporate multiple housings, and one or more of the elements of the present invention may be stored in each of the housings. For example, as shown in FIG. 4, a router 24, and a server 10 may be stored in a first housing 26a, and a computer device 20 may be stored in a second housing 26b. It is also possible for each element of the present invention to be stored in a separate housing. The number of housings, and the elements stored in each housing, can be developed in relation to the environment where an embodiment of the present invention is to be utilized. Each housing may be shaped to enclose the elements that such housing is developed to enclose.

Every housing incorporated in an embodiment of the present invention may be configured to protect one or more elements of the present invention from environmental conditions, such as heat, cold, dryness, wetness, sand, dust, or other environmental conditions. The purpose of every housing is therefore to protect the elements from malfunction that may otherwise occur if the elements were affected by such conditions. A housing may be configured to address a single type of environmental condition, such as a wet environment, or multiple types of environmental conditions, such as hot, dry and sandy environments. The materials that a housing is formed of may be chosen to be impermeable to wet conditions or to have low conductivity of heat or cold. A housing may further incorporate insulation against hot or cold conditions. The configuration of the housing may further be formed to limit the access for dust or sand, or water in any areas of the housing required to achieve ventilation. The foregoing are some examples of configurations of housings that prevent malfunction of elements in some types of environments. One or more housings can be configured to prevent malfunction of the elements of the present invention for any type of environment condition or conditions.

A housing may further be configured to withstand wear and tear. For example, the materials that a housing is formed of may withstand bumping, dropping, heavy objects being placed thereon, pressure being exerted thereon, rough treatment, and other wear and tear. A housing may further be configured to position the elements stored therein in a particular manner that will limit stress upon such elements should any type of treatment that induces wear and tear occur. A housing may further incorporate cushioning to protect the elements therein from the effects of any type of treatment that induces wear and tear.

The elements enclosed in the housing will vary in accordance with embodiments of the present invention. As shown in FIG, 5, in one embodiment of the present invention, the housing 26 may enclose a router 24, battery 28, computer device 20, and server 10.

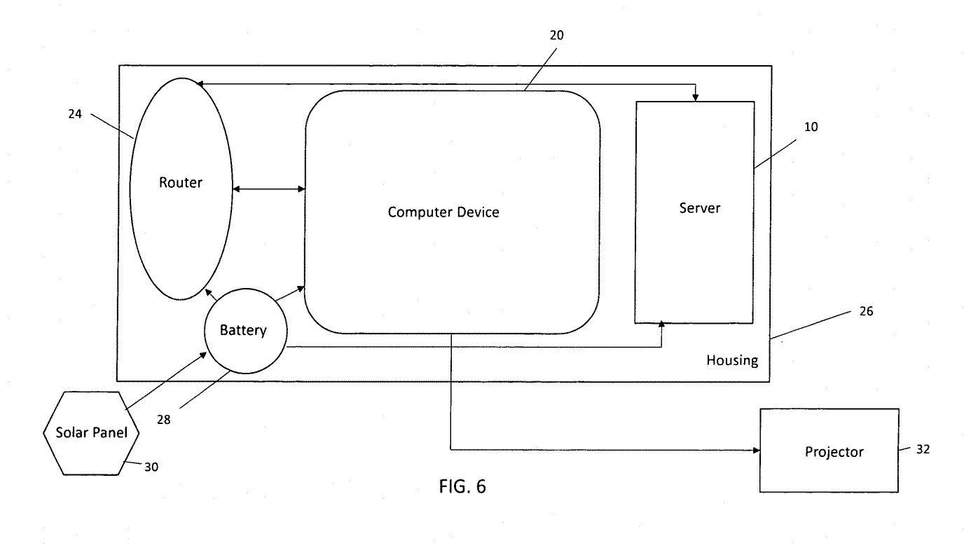

In yet another example, the elements enclosed in the housing may interact with elements external to the housing. As an example, as shown in FIG. 6, a router 24, battery 28, computer device 20, and server 10 may be positioned within the housing. The battery may be charged by a solar panel 30 connected to the battery. The solar panel may be connected to an outer wall of the housing, or may be positioned remotely from the housing.

The computer device 20, may be connectable to a projector 32. The projector may be utilized to project audio/visual materials, such as images, or video, from the computer device to a screen, to thereby be visible to the student(s), or to the educator.

Within a housing two or more of the elements therein may be connected to each other. For example, the battery 28 may be connected to the router 24, computer device 20 and server 10, and the battery may provide power to all of those elements through such connections.

A battery element incorporated in the present invention may also be utilized to recharge the batteries of one or more computer devices that are external to the housing. The housing may incorporate a connector that extends from the battery. A portion of the connector may extend externally from the housing. The connector can be used to connect the battery to one or more computer devices individually or simultaneously (depending on the configuration of the connector), for recharging purposes.

The router may be connected to the computer device and the server, to transfer data bilaterally (hi-directionally) between the router and the computer device and/or the server. The router may be connected to the server via an Ethernet or Wi-Fi connection. If the router is connected to one or more computer devices, the connection may be an Ethernet or Wi-Fi connection. In some embodiments of the present invention, the server may be directly connected to the computer device.

In some embodiments of the present invention, all elements may be operable within the housing. For example, if the computer device is a tablet, the housing may be configured such that the screen of the tablet may be visible through the housing, and be operable via touch screen mechanisms. Such embodiments of the present invention may configured for particularly harsh environmental and/or wear and tear conditions, whereby any prolonged exposure of the elements of the present invention to the environmental conditions or wear and tear conditions have a likelihood of causing the elements to malfunction,

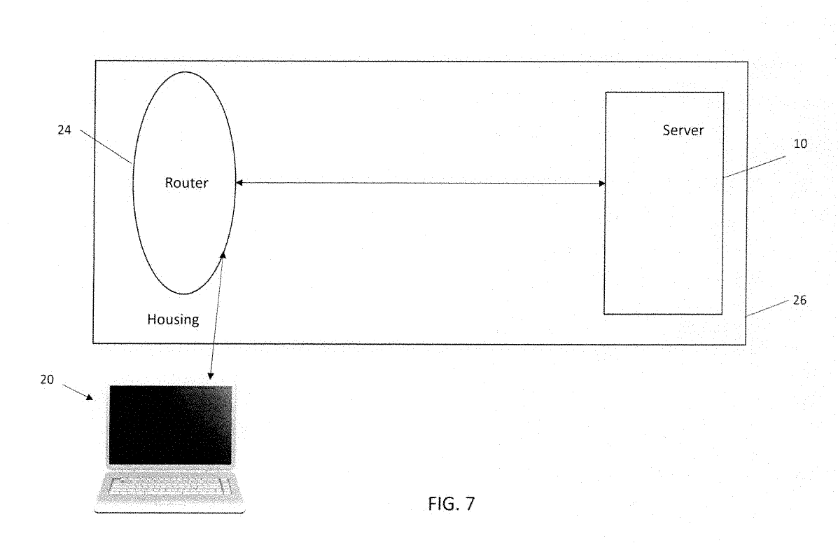

In other embodiments of the present invention elements may be removed from the housing when being utilized. When elements are removed from the housing they may still be connected, via wired or wireless connections, to other elements contained within the housing. As an example, as shown in FIG. 7, the computer device 20 may be removed from the housing to be used by an educator to prepare and/or provide a lesson. The computing device may maintain a bilateral (bi-directional) connection to the router 24. The router maintains a bilateral (bi-directional) connection to the server 10 internally within the housing. Through these connections information may be sent to and from the computer device from the server via the router.

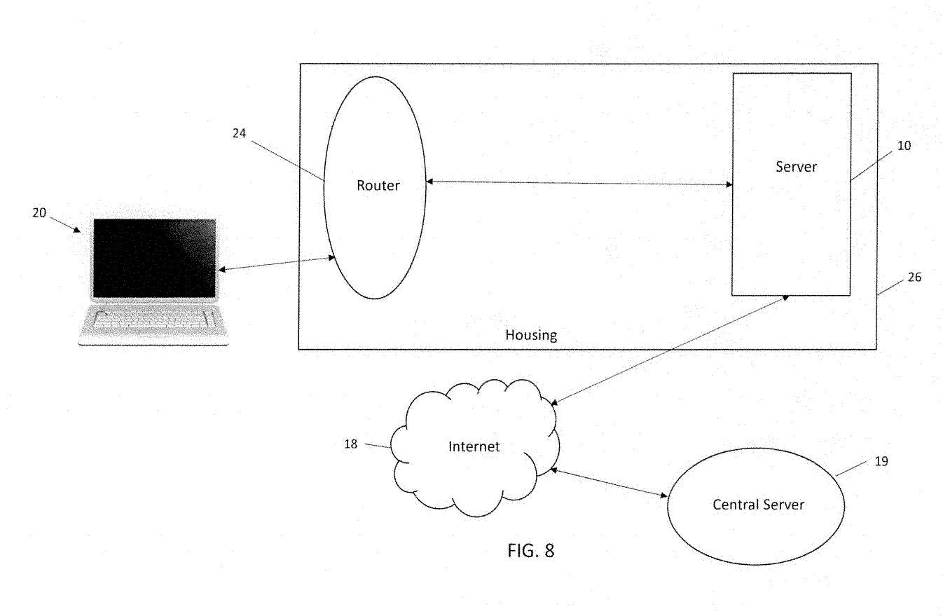

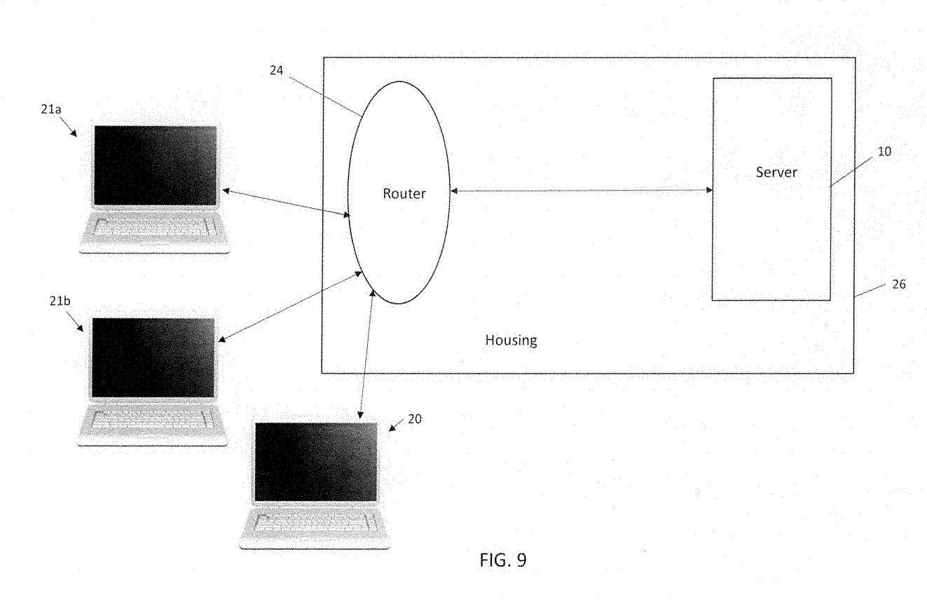

In embodiments of the present invention, as shown in FIG. 8, the server 10, may be connected to the central server 19, or other remote server, via the Internet 18. Data may thereby be transferred (downloaded) from the central server to the server via the Internet. The transferred data is stored on the server, and is accessible by the computer device 20 via the router 24. As shown in FIG. 9, multiple student computer devices 21a, 21b may be connected to the router. Such student computer devices may be utilized by students during the lessons. The student computer devices may access data stored on the server via the router.

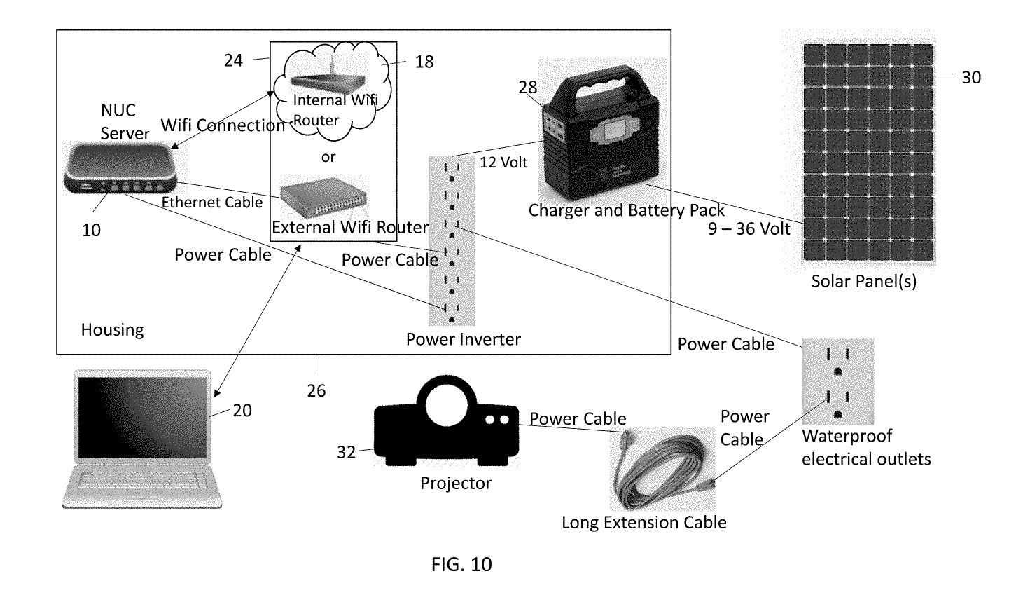

FIG. 10 provides yet another example of a configuration of elements of the present invention, some of the elements being contained within the housing (enclosure), and other elements being outside of the housing. As shown in FIG. 10, the router 24, server 10, power inverter 50, and charger and battery pack 52, may be positioned within a housing 26. The router may incorporate multiple router elements, for example, such as an internal wifi router 48a operable to connect and function with the server 10, and an external wifi router 48b operable to connect and function with the computing device 20 positioned external to the housing.

The charger and battery pack may be connected to a power source external to the housing, such as one or more solar panels 30. The power source will provide a charge of electrical power to the charger and battery, and such electrical power charge will be stored in the battery. The power inverter may be connected to the charger and battery pack, and the power inverter may thereby draw electrical power from the charger and battery. One or more elements may be plugged into outlets in the power inverter. The server and one or more of the router elements may be connected to the power inverter and electrical power may thereby be supplied to such elements. One or more waterproof electrical outlets 42a, 42b external to the housing may further be connected to the power inverter.

One or more external elements may be attached to the one or more waterproof electrical outlets. For example, a projector 40 may be connected to one of the one or more waterproof electrical outlets, and such projector draws electrical power form the charger and battery through such connection. The connection between the projector and one of the one or more waterproof electrical outlets may be via a power cord and plug 46 connected to the projector, and if the projector needs to be positioned farther from the waterproof outlets than the length of such power cord and plug, an extension cord 44 may be positioned between the waterproof outlets and the projector power cord and plug, whereby the extension cord is connected to one of the waterproof electrical outlets at one end and to the power cord and plug of the projector at the other end.

Embodiments of the present invention can be configured to incorporate other external and internal elements. (Internal elements being those elements contained within the housing, and external elements being those elements external to the housing.) For example, embodiments of the present invention can be configured to incorporate other external elements (external to the housing) that can be utilized in association with the computing device and the system of the present invention. Such external elements may also attached to the waterproof electrical outlets in a similar manner as described in relation the projector shown in FIG. 10. Such external elements may include one or more of the following: one or more speakers, one or more microphones, one or more screens, one or more televisions, one or more gaming and entertainment consoles Xbox™ or any other gaming and/or entertainment console), one or more smart home consoles e.g., Amazon Echo™ or any other smart home console), or other elements.

It will be appreciated by those skilled in the art that other variations of the embodiments described herein may also be practiced without departing from the scope of the invention. Other modifications are therefore possible.

We claim:

1. An educational tool, comprising:
a. a router;
b. a server having data relating to one or more lessons stored therein and being bilaterally connected to the router; and
b. a computer device connected to the router, said computer device incorporating a software application operable to prepare the one or more lessons and a computer processor operable to receive the data from the server via the router and to provide such data to a user in accordance with commands of the software application.

2. The educational tool of claim 1, further comprising the one or more lessons each being standalone lessons whereby the user can provided each of the one or more lessons to one or more students without said one or more students having attended any prerequisite lesson.

3. The educational tool of claim 1, further comprising the computer device being connectable to the internet, and the server being operable to identify a URL transmitted to the service from the computer device browser and thereby operate a script to facilitate access to a central server and the receipt of updates from such central sever to the software application of the computer device.

4. The educational tool of claim 1, further comprising the data including one or more of the following: applications to receive updates from the central server to the computer software; DNS server applications; DNS server configurations; lesson planning materials; and lesson content.

5. The educational tool of claim 1, further comprising the one or more lessons incorporating content directed to content-based themes and social and emotional themes.

6. The educational tool of claim 1, further comprising the one or more lessons incorporating content to facilitate assisting students with building and fostering self-efficiency skills and a perception of control.

7. The educational tool of claim 1, further comprising each of the one or more lessons incorporating content directed to two or more levels of learning.

8. The educational tool of claim 1, further comprising the one or more lessons being preparable and teachable to one or more students by a person devoid of instructor training.

9. The educational tool of claim 1, further comprising a rechargeable battery operable to provide power to one or more of the following: the router, the server, the computer device, and one or more external elements, wherein said rechargeable battery is attached to a power source that is one or more solar panels, and the one or more external elements include one or more of the following: one or more projectors; one or more speakers, one or more microphones, one or more screens, one or more televisions, one or more gaming and entertainment consoles, and one or more smart home consoles.

10. The educational tool of claim 1, further comprising a housing being configured to contain one or more of the following:
a. the router;
b. the server;
c. the computer device;
d. a rechargeable battery;
e. a battery charger; and
f. a power inverter.

11. The educational tool of claim 10, further comprising the housing being configured to withstand environmental conditions, including being configured in the manner of one or more of the following:
a. to resist or otherwise expel sand and dust from entering the housing, thereby protecting the contents of the housing from clogging due to sand or dust;
b. to be insulated against cold and heat;
c. to have low functions of conducting of heat and cold;
d. to withstand exposure to environmental elements;
e. to withstand wear and tear, including one or more of the following: bumping, being dropped, and being under weight or other pressure.

12. An educational tool, comprising:
a. a housing containing: a router; and a server having data relating to one or more lessons stored therein and being bilaterally connected to the router; and
b. a computer device connected to the router, said computer device incorporating a software application operable to prepare the one or more lessons and a computer processor operable to receive the data from the server via the router and to provide such data to a user in accordance with commands of the software application.

13. The educational tool of claim 12, further comprising the housing being configured to withstand environmental conditions, including being configured in the manner of one or more of the following:
a. to resist or otherwise expel sand and dust from entering the housing, thereby protecting the contents of the housing from clogging due to sand or dust;
b. to be insulated against cold and heat;
c. to have low functions of conducting of eat and cold;
d. to withstand exposure to environmental elements;
e. to withstand wear and tear, including one or more of the following: bumping, being dropped, and being under weight or other pressure.

14. The educational tool of claim 12, further comprising the server incorporating one or more of the following: a LAMP server, a DNS server and a update daemon.

15. The educational tool of claim 12, further comprising the server being connectable the internet, and via such internet connection being connectable to a central server.

16. The educational tool of claim 12, further comprising the computer device having a browser function incorporated therein.

17. The educational tool of claim 12, further comprising the housing being configured to further contain one or more of the following:
a. the computer device;
b. a rechargeable battery;
c. a battery charger; and
d. a power inverter,

18. The educational tool of claim 12, further comprising a computer device housing being configured contain the computer device and to withstand environmental conditions, including being configured in the manner of one or more of the following:
a. to resist or otherwise expel sand and dust from entering the housing, thereby protecting the contents of the housing from clogging due to sand or dust;
b. to be insulated against cold and heat;
c. to have low functions of conducting of heat and cold;
d. to withstand exposure to environmental elements;
e. to withstand wear and tear, including one or more of the following: bumping, being dropped, and being under weight or other pressure.

19. The educational tool of claim 12, further comprising one or more additional computer devices being connected to the router.

20. The educational tool of claim 12, further comprising a rechargeable battery operable to provide power to one or more of the following: the router, the server, the computer device, and one or more external elements.

21. The educational tool of claim 20, further comprising one or more of the following:
a. the rechargeable battery being attached to a power source that is one or more solar panels; and
b. the one or more external elements including one or more of the following: one or more projectors; one or more speakers, one or more microphones, one or more screens, one or more televisions, one or more gaming and entertainment consoles, and one or more smart home consoles.
